(19) United States
(12) Patent Application Publication
(10) Pub. No.: US 2012/0131065 A1
(43) Pub. Date: May 24, 2012

(54) SYSTEM AND METHOD FOR PROCESSING DATA FOR RECALLING MEMORY

(75) Inventors: Cheon Shu PARK, Daejeon (KR); Jae Hong KIM, Daejeon (KR); Joo Chan SOHN, Daejeon (KR)

(73) Assignee: Electronics and Telecommunications Research Institute, Daejeon (KR)

(21) Appl. No.: 13/198,372

(22) Filed: Aug. 4, 2011

(30) Foreign Application Priority Data
Nov. 22, 2010 (KR) 10-2010-0116115

(51) Int. Cl. G06F 17/30

(52) U.S. Cl. 707/805; 707/E17.03

(57) ABSTRACT

Provided are a system and a method for aiding a user's memory by using a robot. The present invention is provided to aid the user's memory by acquiring image data associated with surrounding situations according to a request from a user, granting a unique ID to data acquired according to a feedback from the user or collected from the outside, classifying and managing the collected data by considering user information, a position, a time, person information and the like, and selecting data which is managed according to a query selected by the user from predetermined queries. According to the present invention, daily activities can be recorded from a user-centered viewpoint and it is possible to easily access even a photo which is not stored in a DB of a robot in link with an SNS.

### RELATED APPLICATIONS

The present application claims priority to, and the benefit of, Korean Patent Application Serial Number 10-2010-0116115, filed on Nov. 22, 2010, the content of which is hereby incorporated by reference.

### BACKGROUND OF THE INVENTION

1. Field of the Invention

The present invention relates to a system and a method for processing data for recalling a memory. More particularly, the present invention relates to a system and a method for processing data for recalling a memory using a robot.

2. Description of the Related Art

As a known method for aiding memory, situations generated in daily life are recorded by installing a camera in the vicinity of a user or making and wearing a photographing device in a human body. However, in this case, the following diversified problems occur. First, a wearable camera device is sensitive to motions of the user or brightness of lighting, such that a blur is generated. Second, it is not easy for a person who wears the camera to photograph a photo including himself/herself and the person generally photographs surrounding situations. Third, in the case of a method of collecting image data by installing the camera, since the cameras should be installed in all places where the user is active, a considerable cost is required and a problem such as infringement of privacy may also be raised. Fourth, in the case of the known data collecting method, since data should be collected and stored periodically according to a predetermined time, vast quantities of data need to be stored and a long data analysis time is required. Fifth, most old persons feel it uncomfortable to wear the device in their bodies.

### SUMMARY OF THE INVENTION

The present invention has been made in an effort to provide a system and a method for processing data for recalling a memory that collect data by using a robot and provides the collected data at a user's desired time for assisting a user in recalling the memory.

An exemplary embodiment of the present invention provides a system for processing data for recalling a memory, the system including: a query information inputting unit provided in a robot and receiving at least one query information; a data detecting unit detecting data associated with an inputter who inputs the query information among stored data on the basis of the inputted query information; and a data displaying unit displaying the detected data to recall the memory of the inputter.

The system may further include: a data collecting unit provided in the robot and collecting user related data whenever the user makes a request; and a data classifying unit classifying the collected data in association with at least one query information.

The data collecting unit may include: a voice/gesture recognizing portion recognizing user's voice or gestures; a voice/gesture analyzing portion analyzing the recognized voice or gesture; and an image data collecting portion (a first image data collecting portion) collecting image data regarding the user by accessing the user if an analysis result value is permission of data collection. Alternatively, the data collecting unit may include: an image acquiring portion acquiring an image including a person positioned within a predetermined distance while stopping or moving; a human body detecting portion detecting a part of a body of the person included in the acquired image; a user determining portion determining whether the person included in the acquired image is a registered user by analyzing a part of the human body which is detected; a query portion querying whether data can be collected when the person included in the acquired image is the registered user; and an image data collecting portion (a second image data collecting portion) collecting the acquired image as the image data regarding the user or recollecting or additionally collecting the image data regarding the user by accessing the user when an answer for the query is permission of data collection.

The data collecting unit may collect user related data from the social network service (SNS) website in which the user is registered.

The data classifying unit may include: a data information generating portion generating information on data for each of the collected data; a query information generating portion generating the query information for each of the collected data on the basis of the generated information; and a collection data classifying portion classifying the collected data by considering the generated query information. The data information generating portion may use at least one of information regarding the user, positional information of a location displayed in the data, information regarding a time when the data are acquired, information regarding a person other than the user displayed in the data, and identification information allocated to the data as the information on the data.

The system may include: a memory cue extracting unit extracting data selected by the user or data of which the number of retrieval times is equal to or more than a reference value as the memory cue among the stored data; and a memory cue storing unit separately storing the extracted memory cue by separating the corresponding memory cue from the stored data.

The data detecting unit and the data displaying unit may be implemented by a GUI, and the GUI may display the detected data by using a screen mounted on the robot.

The data detecting unit may additionally detect the data associated with the inputter from the SNS website.

Another exemplary embodiment of the present invention provides a method for processing data for recalling a memory, the method including: query information inputting of receiving at least one query information by using a robot; data detecting of detecting data associated with an inputter who inputs the query information among stored data on the basis of the inputted query information; and data displaying of displaying the detected data to recall the memory of the inputter.

The system may further include: data collecting of collecting user related data whenever the user makes a request by using the robot; and data classifying of classifying the collected data in association with at least one query information.

The collecting of the data may include: voice/gesture recognizing of recognizing user's voice or gestures; voice/gesture analyzing of analyzing the recognized voice or gesture; and image data collecting (first image data collecting) of collecting image data regarding the user by accessing the user if an analysis result value is permission of data collection. Alternatively, the collecting of the data may include: image acquiring of acquiring an image including a person positioned within a predetermined distance while stopping or moving; human body detecting of detecting a part of a body of the person included in the acquired image; user determining of determining whether the person included in the acquired image is a registered user by analyzing a part of the human body which is detected; querying whether data can be collected when the person included in the acquired image is the registered user; and image data collecting (second image data collecting) of collecting the acquired image as the image data regarding the user or recollecting or additionally collecting the image data regarding the user by accessing the user when an answer for the query is permission of data collection.

In the collecting of the data, user related data may be collected from the social network service (SNS) website in which the user is registered.

The classifying of the data may include: data information generating of generating information on data for each of the collected data; query information generating of generating the query information for each of the collected data on the basis of the generated information; and collection data classifying of classifying the collected data by considering the generated query information. In the generating of the data information, at least one of information regarding the user, positional information of a location displayed in the data, information regarding a time when the data are acquired, information regarding a person other than the user displayed in the data, and identification information allocated to the data may be used as the information on the data.

The method may further include: memory cue extracting of extracting data selected by the user or data of which the number of retrieval times is equal to or more than a reference value as the memory cue; and memory cue storing of separately storing the extracted memory cue by separating the corresponding memory cue from the stored data.

The detecting of the data and the displaying of the data may be implemented by a GUI and in the displaying of the data which is linked with the GUI, the detected data may be displayed by using a screen mounted on the robot.

In the detecting of the data, the data associated with the inputter may be additionally detected from the SNS website.

The present invention can give the following effects by collecting data by using a robot and providing the collected data as a use to help recalling a user's memory when a user wants. First, it is possible to record daily activities at a user-centered viewpoint by collecting a still image by using a robot. Second, since the still image can be collected by using the robot and accessed through a monitor attached to the robot, it is possible to solve inconvenience to wear equipment in a predetermined portion of a human body. Third, it is possible to provide a photo which is not easy to access an elderly care facility or welfare facility by providing a function to view photos of a family, a relative, friends, and the like by using an external social network service (SNS). Fourth, it is possible to reduce a memory cue classifying time and increase personal accuracy for the memory cue through a personal test or a personal questionnaire by using the memory cue to help the memory as user's feedback information. Further, since the robot photographs the still image after getting user's consent, it is possible to imitatively solve a privacy problem.

### BRIEF DESCRIPTION OF THE DRAWINGS

FIG. 1 is a schematic block diagram of a system for processing data for recalling a memory according to an exemplary embodiment of the present invention;

FIG. 2 is a block diagram showing, in detail, an internal configuration of the system for processing data for recalling a memory;

FIG. 3 is a configuration diagram of a memory aiding system for assisting a user in recalling a memory;

FIG. 4 is a flowchart showing a method for processing data for recalling a memory according to an exemplary embodiment of the present invention;

FIG. 5 is a flowchart for assisting a user to recalling a memory by showing a still image photographed by using a robot and using a feedback selected by the user as a memory cue; and

FIG. 6 is a flowchart of collecting photos by using a robot.

### DETAILED DESCRIPTION OF THE EMBODIMENTS

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention. Hereinafter, the preferred embodiment of the present invention will be described, but it will be understood to those skilled in the art that the spirit and scope of the present invention are not limited thereto and various modifications and changes can be made.

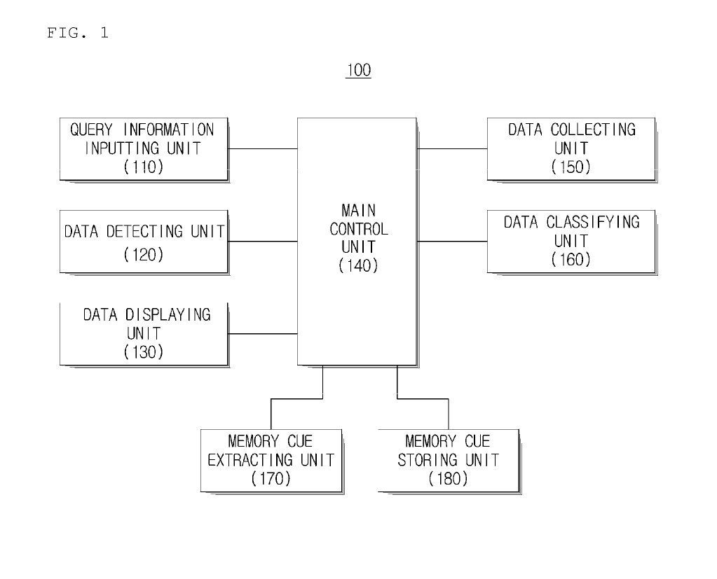

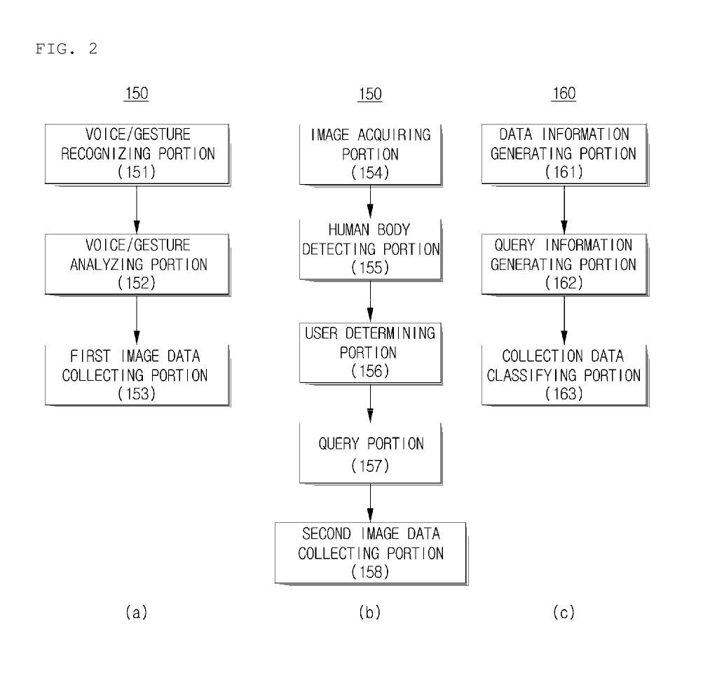

FIG. 1 is a schematic block diagram of a system for processing data for recalling a memory according to an exemplary embodiment of the present invention. FIG. 2 is a block diagram showing, in detail, an internal configuration of the system for processing data for recalling a memory. The following description refers to FIGS. 1 and 2.

Referring to FIG. 1, the system 100 for processing data for recalling a memory includes a query information inputting unit 110, a data detecting unit 120, a data displaying unit 130, and a main control unit 140. The system 100 may provided in a apparatus, for example, a robot.

The system 100 for processing data for recalling a memory assists a user in recalling the memory by a robot's collecting still image data by determining surrounding situation information at a user's desired time, separately storing and managing a memory cue by using a user's feedback, and providing photos of a family or friends by linking an external social network service (SNS) with a photo DB collected by the robot when the user wants to view photos which were photographed in the past.

The inquire information input unit 110 receives at least one query information. In the exemplary embodiment, the query information inputting unit 100 is provided in a robot.

The data detecting unit 120 detects data associated with an inputter who inputs query information among stored data on the basis of the inputted query information.

In the above description, the data includes at least one datum of image data, character data, and the like. The data detecting unit 120 may additionally detect data associated with the inputter from a social network service (SNS) website. In the exemplary embodiment, the SNS website may be any one of an SNS website inputted by the inputter, an SNS website extracted from information regarding the inputter, an SNS website extracted from information regarding the inputter's family or friends, and the like.

The data displaying unit 130 displays the detected data so as to recall the memory of the query information inputter. As the method of displaying data to recall the memory, the data displaying unit 130 may display data by arranging a plurality of photos taken in the same day and the same place according to a temporal sequence or may display data by arranging the plurality of photos through considering an association technique.

The data detecting unit 120 and the data displaying unit 130 are implemented by a graphical user interface (GUI). In this case, the GUI displays the detected data by using a screen mounted on the robot.

The main control unit 140 controls an overall operation of each of the units constituting the system 100 for processing data for recalling a memory.

The system 100 for processing data for recalling a memory may further include a data collecting unit 150 and a data classifying unit 160.

The data collecting unit 150 collects user related data whenever the user makes a request. In the exemplary embodiment, the data collecting unit 150 is provided in the robot. The user related data may be, for example, image data including the user, image data including an image photographing date or information inputted by the user, and the like. The information inputted by the user may be an episode at the time of photographing images, feeling or impression associated with the image, and the like. Meanwhile, the data collecting unit 150 may collect user related data from the social network service (SNS) website in which the user is registered.

In the exemplary embodiment, when the user discovers the robot and calls it through a gesture or voice, the robot approaches to collect data. By considering this case, the data collecting unit 150 may include a voice/gesture recognizing portion 151, a voice/gesture analyzing portion 152, and a first image data collecting portion 153 as shown in FIG. 2A. The voice/gesture recognizing portion 151 recognizes user's voice or gestures. The voice/gesture recognizing portion 152 analyzes the recognized voice or gestures. The first image data collecting portion 153 approaches the user to collect image data regarding the user if the analysis result value is permission of data collection.

Meanwhile, in the exemplary embodiment, the robot discovers an old person through face recognition and asks to the old person “Would you like to be photographed?”. In this case, when the old person says “OK.”, data may be collected. By considering this case, the data collecting unit 150 may include an image acquiring portion 154, a human body detecting portion 155, a user determining portion 156, a query portion 157, and a second image data collecting portion 158 as shown in FIG. 2B. The image acquiring portion 154 acquires an image including a person positioned within a predetermined distance while the robot stops or moves. The human body detecting portion 155 detects a part of a body of the person included in the acquired image. In the above description, a part of the human body may be, for example, a face, an iris, and the like. The user determining portion 156 determines whether the person included in the acquired image is a registered user by analyzing a part of the human body which is detected. The query portion 157 inquires whether data can be collected when the person included in the acquired image is the registered user. The second image data collecting portion 158 collects the acquired image as the image data regarding the user or recollects or additionally collects the image data regarding the user by accessing the user when an answer for the query is permission of data collection.

The data classifying unit 160 classifies the collected data in association with at least one query information. The data classifying unit 160 may include a data information generating portion 161, a query information generating portion 162, and a collection data classifying portion 163 as shown in FIG. 2C. The data information generating portion 161 generates information on data for each of the collected data. The data information generating portion 161 may use at least one of information regarding the user, positional information of a location displayed in the data, information regarding a time when the data are acquired, information regarding a person other than the user displayed in the data, and identification information allocated to the data as the information on the data. The query information generating portion 162 generates the query information for each of the collected data on the basis of the generated information. The collection data classifying portion 163 classifies the collected data by considering the generated query information.

The system 100 for processing data for recalling a memory may further include a memory cue extracting unit 170 and a memory cue storing unit 180. The memory cue extracting unit 170 extracts data selected by the user or data of which the number of retrieval times is equal to or more than a reference value among the stored data as the memory cue. The memory cue storing unit 180 separately stores the extracted memory cue by separating the corresponding memory cue from the stored data.

Next, the system 100 for processing data for recalling a memory will be described as an exemplary embodiment. The system 100 for processing data for recalling a memory according to the exemplary embodiment as a memory aiding system using the robot is for use in assisting the user in recalling the memory by collecting photos by using the robot, extracting and managing the memory cue through the user's feedback, and showing photos associated with experiences and events generated in daily life by linking the database (DB) and the social network service (SNS) through the user's desired time or recognition. In the above description, the user may be, for example, an old person, a person having memory disturbance, and the like.

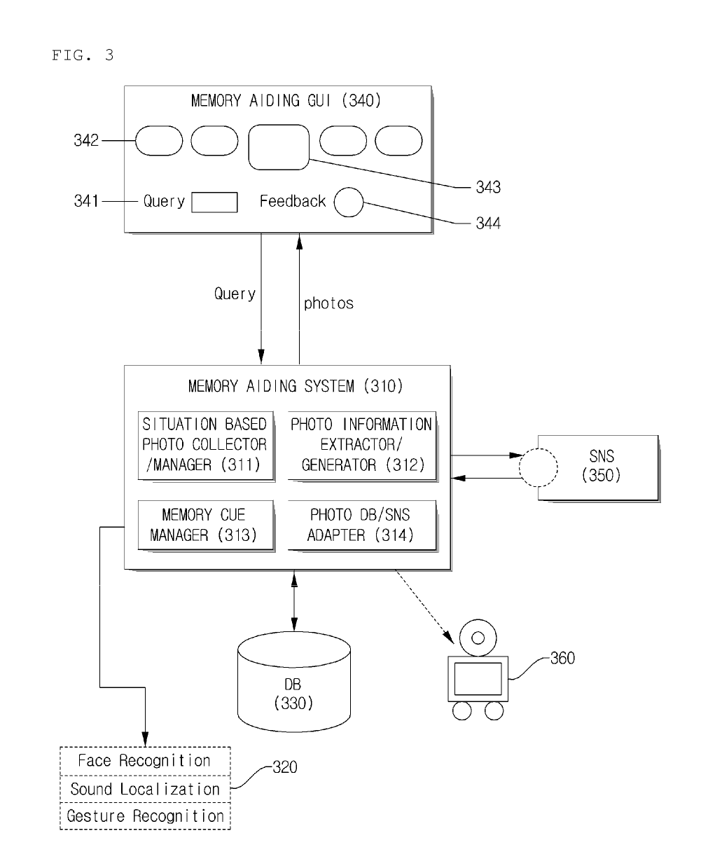

FIG. 3 is a configuration diagram of a memory aiding system for assisting a user in recalling a memory. The memory aiding system 310 is constituted by a situation based photo collector/manager 311, a photo information extractor/generator 312, a memory cue manager 313, and a photo DB/SNS adapter 314.

In the situation based photo collector/manager 311, in the case in which the user discovers the robot and calls it through the gesture or voice, the robot approaches the user or in the case in which the robot discovers the old person through face detection/face recognition and asks to the old person “Would you like to be photographed?”, the robot take a photo for the old person when the old person says “OK.”. In this case, the situation based photo collector/manager 311 is a module in which a photo is taken by using the camera attached to the robot, the robot calls an HRI recognition library 320 including gesture recognition, face detection, sound localization, voice recognition and the like and the robot moves or takes and manages a photo on the basis of the recognition result. The situation based photo collector/manager 311 is a concept corresponding to the data collecting unit 150 of FIG. 1.

The photo information extractor/generator 312 extracts user information, a position, a time, and person information included in the photo by targeting the photographed photo or the photo brought from the social network service (SNS) or generates information on the photo by granting a unique ID to the photo. Further, the photo information extractor/generator 312 is a module that processes a result by using a face recognizing library in order to extract the person information included in the photo. The information is applied to DB schema in being stored in a photo DB 330 and is used as meta information associated with the photo. The photo information extractor/generator 312 is a concept corresponding to the data classifying unit 160 of FIG. 1.

The memory cue manager 313 is a module that manages feedback data of the old person in order to use a selectively viewed photo or a frequently viewed photo when the user shows the photo through the robot as memory cues by receiving the feedback on the corresponding photos and classifies and provides events by using the feedback data when the old person requests retrieval. The memory cue manager 313 is a concept corresponding to the memory cue extracting unit 170 and the memory cue storing unit 180 of FIG. 1.

The photo DB/SNS adapter 314 prepares an SQL inquiry sheet on the basis of the generated photo information and stores it in the database and extracts a result of a query required by a memory aiding GUI 340 and provides it. Further, the photo DB/SNS adapter 314 is a module that is connected to the external social network service (SNS) 350 to bring and manage the registered photo data. The photo DB/SNS adapter 314 is a concept corresponding to the data detecting unit 120 of FIG. 1.

The memory aiding GUI 340 uses a screen mounted on the robot 360 and provides an interface that shows photos 342 collected as recent experiences or event data when the user makes a query 341 through desired time, place, person, and the like. Further, the memory aiding GUI 340 includes an interface that can give a feedback 344 when the user is interested in the selected photo 343 when the selected photo is viewed to the user while being enlarged or highlighted. The memory aiding GUI 340 is a concept corresponding to the information input unit 110 of FIG. 1. In this case, the robot 360 is a concept corresponding to the data displaying unit 130 of FIG. 1.

The memory aiding system 310 should recognize a user's calling method in order to take a photo when the user make a call by using the robot 360 mounted with the camera and the screen. As a result, the situation based photo collector/manager 311 of the memory aiding system recognizes the user's call by using the HRI recognizing library 320 including face recognition, gesture recognition, sound localization, voice recognition, and the like. For example, when the user takes a gesture meaning “Come here.” to the robot by wave his/her hand, the robot sends a result recognized by a gesture recognizer to the situation based photo collector/manager 311 and the robot moves to the user. In this case, the robot shows on the screen or asks through text to speech (TTS) “Would you like to be photographed?” for verification. When the old person likes to be photographed, the robot takes a photo. The collected photo is stored in the photo database 330.

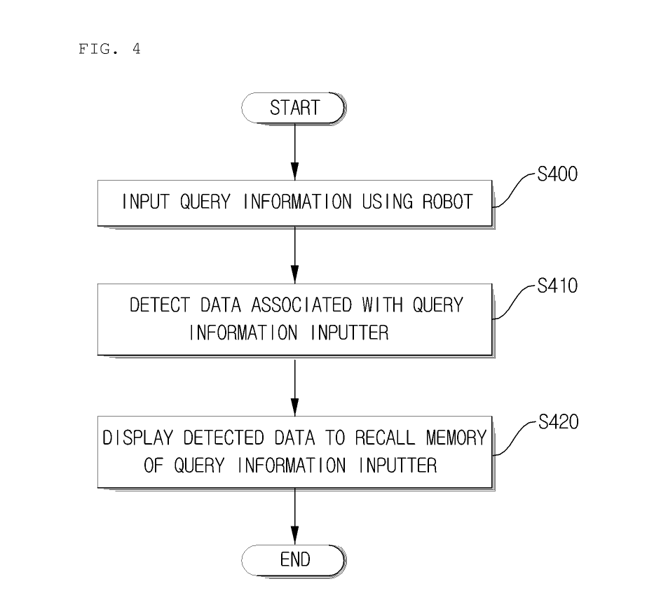

Next, a method for processing data for recalling a memory of the system 100 for processing data in recalling a memory according to an exemplary embodiment will be described. FIG. 4 is a flowchart showing a method for processing data for recalling a memory according to an exemplary embodiment of the present invention. The following description refers to FIG. 4.

First, the query information inputting unit 110 receives at least one query information by using the robot (a query information inputting step, S400).

Thereafter, the data detecting unit 120 detects data associated with an inputter who inputs inquiry information among stored data on the basis of the inputted inquiry information (a data detecting step, S410). In the data detecting step (S410), the data associated with the inputter may be additionally detected from an SNS website.

Thereafter, the data displaying unit 130 displays the detected data to recall the memory of the inputter (a data display step, S420).

The data detecting step (S410) and the data displaying step (S420) may be implemented by a GUI. In this case, in the data displaying step (S420) which is linked with the GUI, the detected data may be displayed by using the screen mounted on the robot.

In the exemplary embodiment, the method for processing data for recalling a memory may further include a data collecting step and a data classifying step. In the data collecting step, the data collecting unit 150 collects data associated with a user whenever the user makes a request by using the robot. In the data classifying step, the data classifying unit 160 classifies the collected data in association with at least one query information. The data collecting step and the data classifying step may be performed before the query information inputting step (S400).

As a first exemplary embodiment, the data collecting step may include a voice/gesture recognizing step, a voice/gesture analyzing step, and a first image data collecting step. In the voice/gesture recognizing step, the voice/gesture recognizing portion 151 recognizes user's voice or gestures. In the voice/gesture analyzing step, the voice/gesture analyzing portion 152 analyzes the recognized voice or gestures. In the first image data collecting step, when an analysis result value is permission of data collection, the first image data collecting portion 153 approaches the user to collect image data regarding the user.

As a second exemplary embodiment, the data collecting step may include an image acquiring step, a human body detecting step, a user determining step, a querying step, and a second image data collecting step. In the image acquiring step, the image acquiring portion 154 acquires an image including a person positioned within a predetermined distance while the robot stops or moves. In the human body detecting step, the human body detecting portion 155 detects a part of a human body of a person included in the acquired image. In the user determining step, the user determining portion 156 determines whether the person included in the acquired image is a registered user by analyzing a part of the human body which is detected. In the querying step, the query portion 157 queries whether data can be collected when the person included in the acquired image is the registered user. In the second image data collecting step, the second image data collecting portion 158 collects the acquired image as the image data regarding the user or recollects or additionally collects the image data regarding the user by accessing the user when an answer for the inquiry is permission of data collection.

Meanwhile, in the data collecting step, the data collecting unit 150 may collect user related data from the social network service (SNS) website in which the user is registered.

The data classifying step may include a data information generating step, a query information generating step, and a collection data classifying step. In the data information generating step, the data information generating portion 161 generates information on data for each collected datum. In the data information generating step, the data information generating portion 161 may use at least one of information regarding the user, positional information of a location displayed in the data, information regarding a time when the data are acquired, information regarding a person other than the user displayed in the data, and identification information allocated to the data as the information on the data. In the query information generating step, the query information generating portion 162 generates query information for each collected datum on the basis of the generated information. In the collection data classifying step, the collection data classifying portion 163 classifies the collected data by considering the generated query information.

In the exemplary embodiment, the method for processing data for recalling a memory may further include a memory cue extracting step and a memory cue storing step. In the memory cue extracting step, the memory cue extracting unit 170 extracts data selected by the user or data of which the number of retrieval times is equal to or more than a reference value as the memory cue among the stored data. In the memory cue storing step, the memory cue storing unit 180 separately stores the extracted memory cue by separating the corresponding memory cue from the stored data. The memory cue extracting step and the memory cue storing step may be performed as intermediate steps of the information inputting step (S400) and the data detecting step (S410).

Next, various implementation examples of the method for processing data in recalling a memory are will be described.

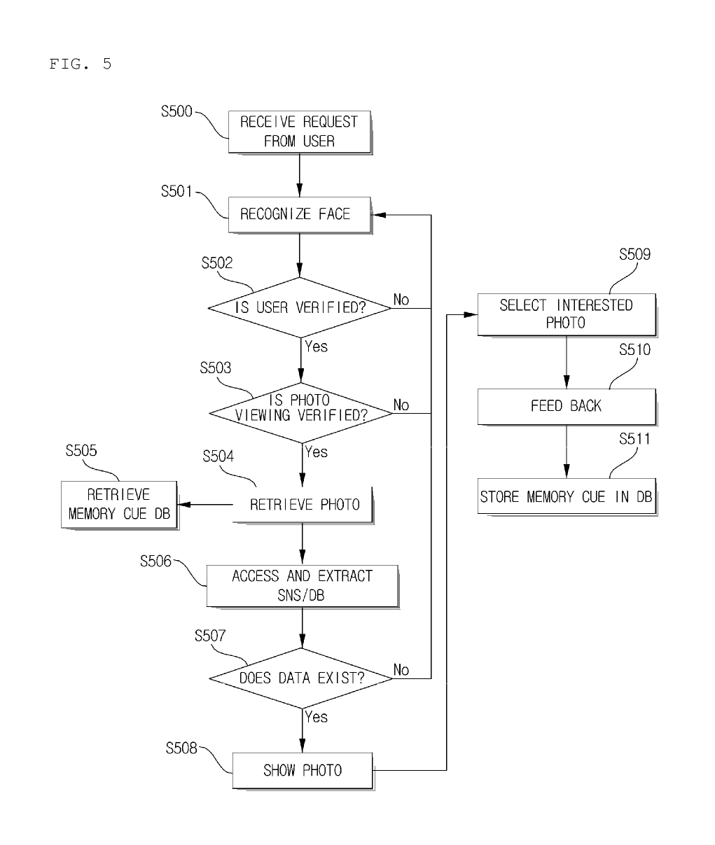

FIG. 5 includes a flow for assisting a user to recalling a memory by showing a still image photographed by using a robot and using a feedback selected by the user as a memory cue. When the user discovers the robot and the user wants to view a photo (S500), the robot recognizes the user through face recognition (S501). In the case in which the robot verifies whether the corresponding user is a registered user (S502), the robot performs a photo retrieving step (S504) when the user says “OK.” through a photo view verifying step (S503) using TTS or the screen including “Would you like to view a photo?”. In the photo retrieving step, the robot retrieves a predetermined time, place, or person through a query interface of a memory aiding GUI. During this step, a result is brought by retrieving a memory cue DB (S505), the robot may be connected with a photo collecting DB by using an API provided form an external social network service (SNS), and recently registered photos of family and friends are brought. The photos of family or friends are provided to an old person who lives only in a long-term care facility or elderly welfare facility to help psychological/emotional stability. When the retrieved result is present (S507), the photos are shown (S508). The user selects interested photos while viewing the photos through a memory aiding GUI screen (S509) and the memory cues are stored in the DB (S511) through the feedback of photos which is of help to the memory or interested photos (S510).

The photos selected by the user may be used as the memory cues. In one of methods for finding the memory cues, the cues should be found by observing events, experience, action, and the like generated in daily life together with a subject. However, in this method, a lot of time is required and an accurate memory cue may be found only when a caregiver sharing the memory is present. Further, since the memory cues are different depending on a personal characteristic, the type of the experience, a place, a person together with the user, and the like, it is difficult to collect information. Therefore, in the exemplary embodiment, as a method for providing the memory cues, when the collected target photos are shown through the memory aiding GUI screen of the robot, the user (old person, persons having memory disturbance, or the like) selects impressive photos or interested photos and when the user gives the feedback of the photos, the photos are stored in the DB to be used as the memory cues.

The robot may provide the photos of his/her family or friends in link with the SNS. Photos during a predetermined period (ex., recent photos) are brought by accessing the social network service (SNS) of which the API is opened to be shown through the robot in order to provide the photos of the family or friends to the old person who lives in a care facility or welfare facility.

In the case of storing the photos, a person together with the old person is verified by comparing the photographed photos with family or friends' faces which are previously registered by using a face recognizing library and a recognition list, a position, a photographing time, a photographing requester, unique photo ID information, and the like which are acquired through the verification are generated to be used as index information for retrieval.

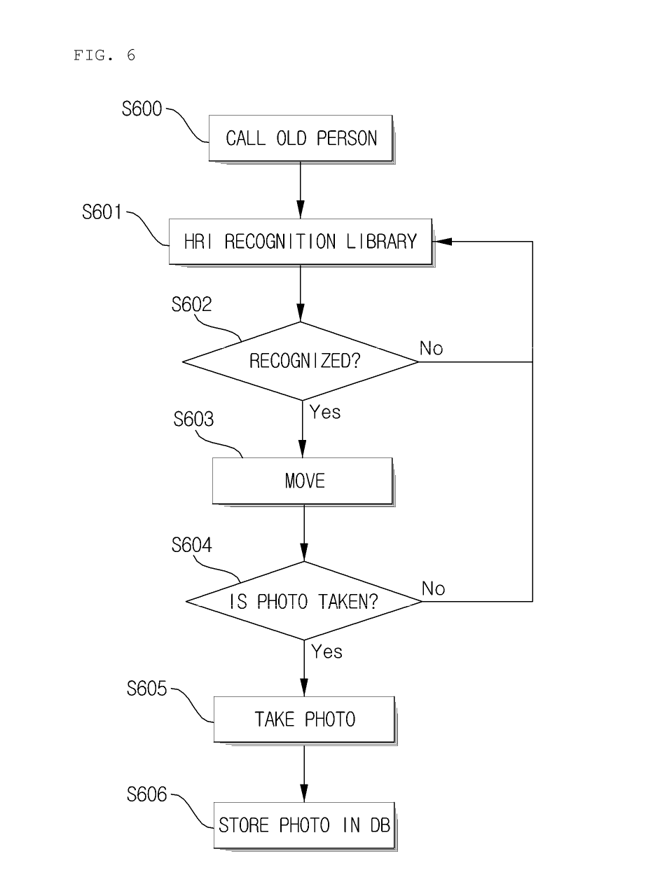

FIG. 6 is a flowchart of collecting photos by using a robot. When photos are photographed by using the robot, photos including the user may be collected and it is possible to minimize a privacy problem due to verification of user's consent to photographing.

When the user calls the robot through a gesture, voice, a signal, and the like (S600), the robot performs a recognition process by using an HRI recognizing library including gesture recognition, voice recognition, sound localization, and the like (S601). When the robot recognizes user's call (S602), the robot moves to the user (S603) and verifies whether the user is photographed to the user (S604). When the user consents to photographing, the robot takes a photo by using a camera attached thereto (S605) and stores the corresponding photo in a photo DB (S606). The robot stands by until another call is generated when the user does not consent to photographing in taking a photo.

The present invention can be applied to interaction intermediate related technology between a human and a robot.

The spirit of the present invention has been just exemplified. It will be appreciated by those skilled in the art that various modifications, changes, and substitutions can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A system for processing data for recalling a memory, comprising:
a query information inputting unit receiving at least one query information;
a data detecting unit detecting data associated with an inputter who inputs the query information among stored data on the basis of the inputted query information; and
a data displaying unit displaying the detected data to recall the memory of the inputter.

2. The system of claim 1, further comprising:
a data collecting unit collecting user related data whenever the user makes a request; and
a data classifying unit classifying the collected data in association with at least one query information.

3. The system of claim 2, wherein the data collecting unit includes:
an image acquiring portion acquiring an image including a person positioned within a predetermined distance while stopping or moving;
a human body detecting portion detecting a part of a body of the person included in the acquired image;
a user determining portion determining whether the person included in the acquired image is a registered user by analyzing a part of the human body which is detected;
a query portion querying whether data can be collected when the person included in the acquired image is the registered user; and
an image data collecting portion collecting the acquired image as the image data regarding the user or recollecting or additionally collecting the image data regarding the user by accessing the user when an answer for the query is permission of data collection.

4. The system of claim 2, wherein the data collecting unit collects user related data from the social network service (SNS) website in which the user is registered or the data detecting unit additionally detects the data associated with the inputter from the SNS website.

5. The system of claim 2, wherein the data classifying unit includes:
a data information generating portion generating information on data for each of the collected data;
a query information generating portion generating the query information for each of the collected data on the basis of the generated information; and
a collection data classifying portion classifying the collected data by considering the generated query information.

6. The system of claim 5, wherein the data information generating portion uses at least one of information regarding the user, positional information of a location displayed in the data, information regarding a time when the data are acquired, information regarding a person other than the user displayed in the data, and identification information allocated to the data as the information on the data.

7. The system of claim 1, further comprising:
a memory cue extracting unit extracting data selected by the user or data of which the number of retrieval times is equal to or more than a reference value as the memory cue among the stored data; and
a memory cue storing unit separately storing the extracted memory cue by separating the corresponding memory cue from the stored data.

8. The system of claim 1, wherein the data detecting unit and the data displaying unit are implemented by a GUI, and the GUI displays the detected data by using a screen mounted on the robot.

9. A method for processing data for recalling a memory, comprising:
query information inputting of receiving at least one query information by using a robot;
data detecting of detecting data associated with an inputter who inputs the query information among stored data on the basis of the inputted query information; and
data displaying of displaying the detected data to recall the memory of the inputter.

10. The method of claim 9, further comprising:
data collecting of collecting user related data whenever the user makes a request by using the robot; and
data classifying of classifying the collected data in association with at least one query information.

11. The method of claim 10, wherein the collecting of the data includes:
image acquiring of acquiring an image including a person positioned within a predetermined distance while stopping or moving;
human body detecting of detecting a part of a body of the person included in the acquired image;
user determining of determining whether the person included in the acquired image is a registered user by analyzing a part of the human body which is detected;
querying whether data can be collected when the person included in the acquired image is the registered user; and
image data collecting of collecting the acquired image as the image data regarding the user or recollecting or additionally collecting the image data regarding the user by accessing the user when an answer for the query is permission of data collection.

12. The method of claim 10, wherein in the collecting of the data, user related data is collected from the social network service (SNS) website in which the user is registered or in the detecting of the data, the data associated with the inputter is additionally detected from the SNS website.

13. The method of claim 10, wherein the classifying of the data includes:
data information generating of generating information on data for each of the collected data;
query information generating of generating the query information for each of the collected data on the basis of the generated information; and
collection data classifying of classifying the collected data by considering the generated query information.

14. The method of claim 13, wherein in the generating of the data information, at least one of information regarding the user, positional information of a location displayed in the data, information regarding a time when the data are acquired, information regarding a person other than the user displayed in the data, and identification information allocated to the data is used as the information on the data.

15. The method of claim 9, further comprising:
memory cue extracting of extracting data selected by the user or data of which the number of retrieval times is equal to or more than a reference value as the memory cue; and
memory cue storing of separately storing the extracted memory cue by separating the corresponding memory cue from the stored data.

16. The method of claim 9, wherein the detecting of the data and the displaying of the data are implemented by a GUI and in the displaying of the data which is linked with the GUI, the detected data is displayed by using a screen mounted on the robot.
